(19) United States
(12) Patent Application Publication
(10) Pub. No.: US 2008/0021739 A1
(43) Pub. Date: Jan. 24, 2008

(54) INTERNET BROWSER BASED ELECTRONIC MEDICAL RECORD DATABASE MANAGEMENT SYSTEM AND METHOD

(76) Inventor: David L. Brock, Natick, MA (US)

Correspondence Address: MCHALE & SLAVIN, P.A., 2855 PGA BLVD, PALM BEACH GARDENS, FL, 33410, US

(21) Appl. No.: 11/458,480

(22) Filed: Jul. 19, 2006

(51) Int. Cl. G06F 19/00

(52) U.S. Cl. 705/3

(57) ABSTRACT

A computer implemented medical record database management system including access by individual patients. A healthcare product or service advertiser can send one or more advertisements to a central server. These advertisements can include, but are not limited to, healthcare products and/or services, medical products and/or services, prescriptions for pharmaceuticals, non-prescription medicines, etc. Each advertisement is linked to one or more key words. These key words generally reference medical conditions. These keys may also relate to pharmaceuticals or other healthcare descriptions. Scripts may also be used in addition to keys to enable more complex correlations of a medical condition or combination of conditions or health information to a particular advertisement. The advertisements may be accessed by individual patients.

### FIELD OF THE INVENTION

Medical records are still kept mainly in paper files and manual folders. These files could be transferred to electronic databases. These databases can be accessed by anyone with the proper authorization and can be securely sent electronically over the Internet to other doctors and hospitals

### BACKGROUND OF THE INVENTION

The invention generally relates to electronic medical records (EMR) coupled with the use of the Internet and web browser based technology to view, edit and manipulate those records. The invention also describes a means to present relevant healthcare product information to viewers of those medical records without compromising patient safety and privacy.

The Internet is a vital tool for communication and dissemination of healthcare information. Recently the Internet, web browsers and client-side scripting, have been used to create software applications ‘on-demand.’ This allows once traditional computer applications to be recreated within any web browser from any location. Furthermore software upgrades, data management and multiple-user coordination can occur effortlessly over the Internet. Despite these advances in information technology, medical information and patient records are, for the most part, based on paper records and manual folders. This leads to unnecessary waste, medical errors, data inaccuracies, additional labor and increased cost. The transition for traditional medical records to digital media requires technological innovations in medical data capture, simplified and intuitive user interfaces and, above all, an effective business model cost distribution and financial compensation. The invention uses existing and new technologies in an innovative way to greatly simplify electronic medical records software, while simultaneously reducing operating cost through appropriate and discreet advertising subsidies.

### DESCRIPTION OF THE PRIOR ART

Mayaud, U.S. Pat. No. 5,845,255 discloses an electronic prescription creation system for physicians which captures into a prescription a patient condition-objective of the prescribed treatment and provides for an assembly of patient records from different sources. Alternative drugs and side affects of drugs are readily available to the physician to assist him in prescribing the correct drugs and treatment. The database may also be accessed by pharmacies, HMO's, hospitals, insurance companies, other physicians, etc. However, this system does not permit the patient to access his or her own information, nor does it permit a pharmaceutical company to place an advertisement on a web page which the patient can access.

Trusheim et al., U.S. Pat. No. 6,385,589 discloses a system for managing the health care of a plurality of members. The medical histories of the members are retained in a database. Also, when a medical event for an individual arises, a coordination specialist can use the system to track the treatment of the individual and identify any possible risk situation. The system also allows the coordination specialist to contact the health care services and other providers in the area. This system does not permit the patient to access his or her own information, nor does it permit a pharmaceutical company to place an advertisement on a web page which the patient can access.

### SUMMARY OF THE INVENTION

Through a novel assemblage of technologies, the present invention provides a means to simplify electronic medical record software and reduce costs through interactive web-based technologies and on-line product advertising. The invention also provides a rapid prescription system that simplifies physician's orders while increasing prescription security.

Accordingly, it is an objective of the instant invention to enable Internet based medical advertising in medical databases.

It is a further objective of the instant invention to enable the medical advertisers to target their advertisements to individuals how would benefit the most from the particular product.

It is yet another objective of the instant invention to keep the identity of each individual patient confidential and access to their information possible only by authorized individuals.

It is a still further objective of the invention to have the advertisers pay for the advertisements to help offset the cost of maintaining the system.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a diagrammatic representation of the essential components of the invention;

FIGS. 2A and 2B illustrate screen captures of the healthcare manufactures secure web portal;

FIGS. 3A and 3B illustrate screen captures of the user login and main web page;

FIG. 4 illustrates a screen capture of the search results screen;

FIG. 5 illustrates a screen capture of the patient record;

FIG. 6 illustrates a screen capture of the patient record edit page;

FIG. 7 illustrates a screen capture of the rapid pharmaceutical prescription system;

FIG. 8 is a diagrammatic representation of the rapid pharmaceutical prescription system; and

FIG. 9 is a second embodiment of the invention.

### DETAILED DESCRIPTION OF THE INVENTION

The invention provides a novel approach for using web browser-based software and Internet advertising in a medical application. In the preferred embodiment, a healthcare product or service advertiser sends one or more advertisements to a central server. These advertisements can include, but are not limited to, healthcare products and/or services, medical products and/or services, prescriptions for pharmaceuticals, non-prescription medicines, etc. Each advertisement is linked to one or more key words. These key words generally reference medical conditions, such as those specified in International Statistical Classification of Diseases and Related Health Problems (ICD), a detailed description of known diseases and injuries. These keys may also relate to pharmaceuticals or other healthcare descriptions. Scripts may also be used in addition to keys to enable more complex correlations of a medical condition or combination of conditions or health information to a particular advertisement.

The advertisements and key words are pooled in a central repository, thus eliminating any correlation of the advertisement with a particular patient by the advertiser. In this way privacy and anonymity are preserved for both the healthcare provider and patient. This pool of advertisements and key words may be transmitted to multiple local sites, such as in the clinic or hospital, eliminating the delay caused by retrieving information from a remote site. Incremental messages may be sent between the central repository and the remote sites to maintain synchronization among all copies of the advertising database. Since these data and their transmissions are not related to a particular patient of case, privacy and anonymity are preserved.

In a preferred, albeit non-limiting embodiment, advertisers pay for the advertisements based on exposure time and key words, though many other payment schemes are possible. These include competitive bidding through public or private online auctions, or payment plans based on “hit” rates or advertisement usage.

The advertisements are placed within an operational electronic medical record (EMR) application. In the preferred embodiment, the EMR application is designed as an interactive web-based software application. In this embodiment, functions are divided between a web server and a client computer and communications take place across the network, which is either a local area network (LAN) or wide are network (WAN), such as the Internet.

There are many advantages to a web browser based application, including (1) automatic upgrade and distribution of software and user interface components, (2) centralization and synchronization of disparate data, (3) standard web languages and communication protocols and (4) standard and universally accepted software interface using commercial web browsers, such as Microsoft Internet Explorer™, Mozilla Firefox™, Apple Safari™, Opera™, AOL Netscape Navigator™, among others. Other advantages include the seamless integration with wireless devices including wireless digital tablets, personal digital assistants (PDAs), mobile telephones, and others. Further advantages include the possible future integration with wireless devices such as biometric sensors, medical equipment, and wireless tracking technologies for both devices and patients.

Although we describe a web browser based application in this preferred embodiment, many other software solutions are possible including traditional Microsoft Windows™, UNIX and Apple Computer software applications, as well as add-ons or “plug-ins” to commercial EMR and healthcare information technology (IT) solutions.

In the web browser based solution, healthcare providers and patients within a closed local area network may access a local server, which retrieves patient records and displays these on the commercial web browser. These patient records will contain key words, or may through a software algorithm generate key words, which are then correlated to the patient record at the local server.

Security systems may be placed on the server to prevent any outside or unauthorized access to the database, key words, advertisements, patient records or correlated data. In the preferred embodiment, only those who are authorized to view a particular record would see any correlated product information.

Product information, as provided by the pharmaceutical manufacturer, may include traditional advertisements, recent medical research, journal references, or other relevant and appropriate healthcare information related to the product or service. In the preferred embodiment, these product data are presented unobtrusively to the periphery of the main view screen. In this way the product information would not interfere with medical practice, but provide a direct avenue for product data to be disseminated to the healthcare provider or patient.

One of the advantages of this invention is the provision for advertising revenue to offset the costs of electronic medical record software, distribution and maintenance, while providing high levels of security and patient privacy and anonymity. Traditional web-based solutions do not provide this security and privacy, while traditional EMR solutions do not provide this revenue source. Thus the present invention provides a vital link between online advertising and medical privacy as required by healthcare regulatory bodies.

In addition to use within a local area network, the present invention may also be applied across the wide area network—particularly the Internet. In this case, security and privacy are of very greater significance. In this case, the application may employ all the traditional Internet based security measures, including usernames/passwords, secure sockets layer (SSL) and secure HTTP (S-HTTP), as well as traditional electronic security systems, including wireless and magnetic strip access cards.

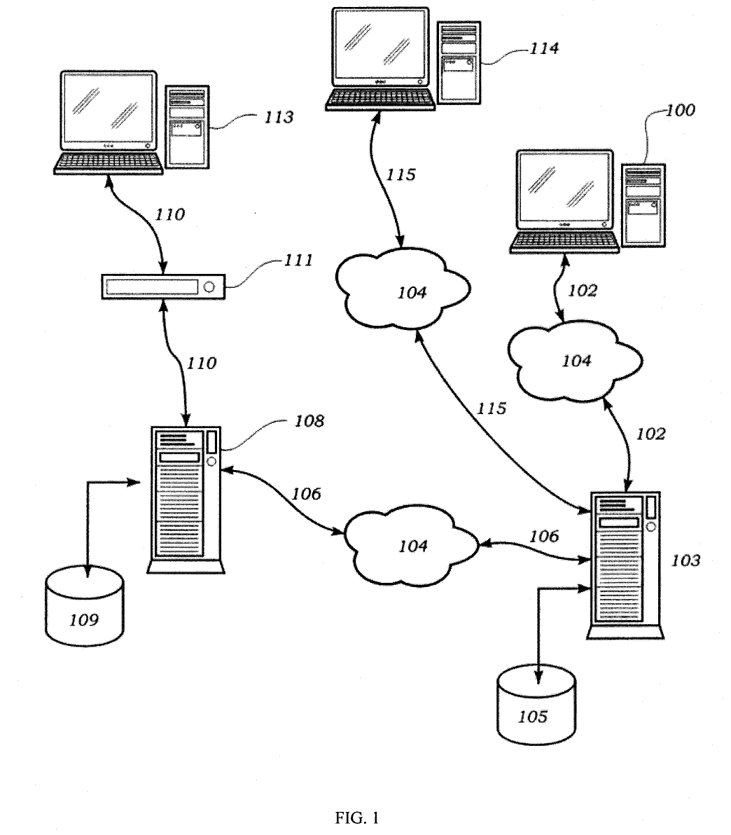

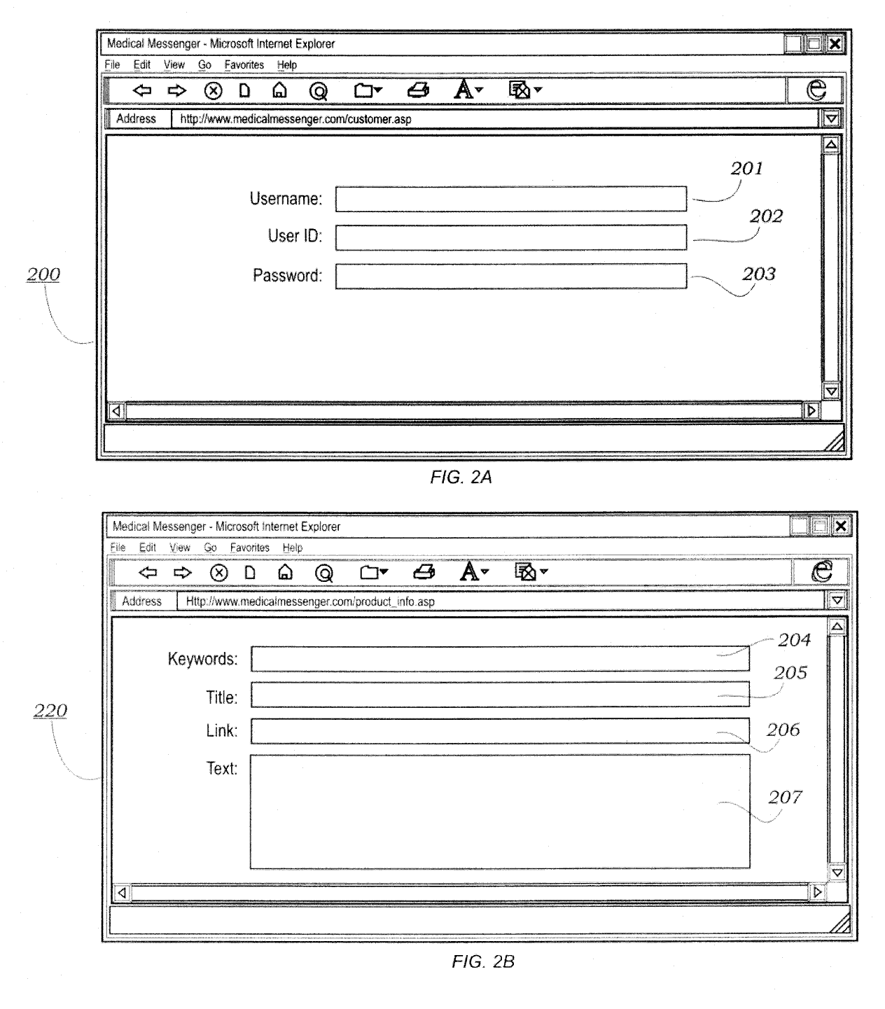

FIG. 1 shows the general components of the invention and the overall structure of the system. Starting from the healthcare product manufacturer's computer system access to a secure web portal located on a central server 103 is gained via the Internet 104. In the preferred embodiment, this link is established via the secure sockets layer (SSL) and secure HTTP (S-HTTP), though other security measures may apply. Once a secure link is established the manufacturer may select one or more key words and a time span, together with a short product promotional consisting of a title line, body and link. The interface is described further in FIG. 2. Once the information is verified, including appropriate username, password, account, key words, promotional document and time span, an electronic invoice is automatically generated and sent to the company. In this way the process of advertisement and billing are automatically generated and managed electronically.

A pool of product promotion data then reside on a database 105 on the central server 103. These data are then transmitted in whole or in part to local servers 108 and stored in local databases 109 that reside in regional clinics and hospitals. In this way communication delays are avoided and security is increased by avoiding individual requests to the central server 103.

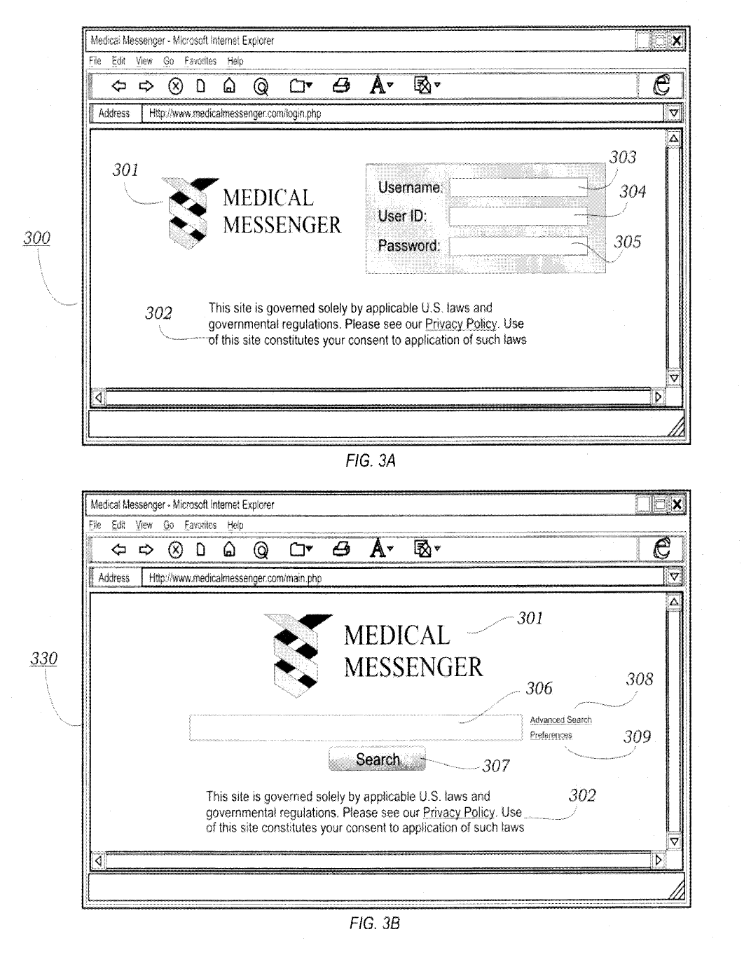

Within a local area network (LAN), represented by 108-113, an interactive web-based application manages patient information and product data. In this case a healthcare provider using local computer system 113 accesses the local database 109 via a LAN 110 and local server 108 possibly using one or more local routers 111. Medical information is viewed, edited and manipulated using a commercial web browser, such as such as Microsoft Internet Explorer™, Mozilla Firefox™, Apple Safari™, Opera™, or AOL Netscape Navigator™, linking to a web server 109 via the LAN 110. Key words from patient records are coupled with key words from product promotion data. These key words may include the International Statistical Classification of Diseases and Related Health Problems (ICD), and pharmaceutical data, including the Anatomical Therapeutic Chemical Classification System is used for the classification of drugs, which is controlled by the World Health Organization (WHO) Collaborating Centre for Drug Statistics Methodology. The local web server 108 assembles a web page collating both patient and product information and returns these data to the local web client 113. This local user interface is described in more detail in FIGS. 3-8.

The interactive web-based application describe above may employ various web technologies, languages and protocols. These include, but are not limited to, Web Services defined by (1) the Representational State Transfer (REST) or (2) the Web Services Description Language (WSDL) and the Simple Object Access Protocol (SOAP). Both of these methods communicate over the Internet using structure messages—the extensible Markup Language (XML) or SOAP messages—according to a well defined schema—either XML Schema or WSDL.

In addition to the detailed electronic medical records stored in the local server 108, summarized data may be transmitted to the central server 103 via the Internet 104 using secure communication. This summarized information is generally intended for the patient rather than the healthcare provider. As in the local area network, the user using a local client computer 114 accesses the central database 105 via the Internet 104 and central server 103 using secure network communication 115.

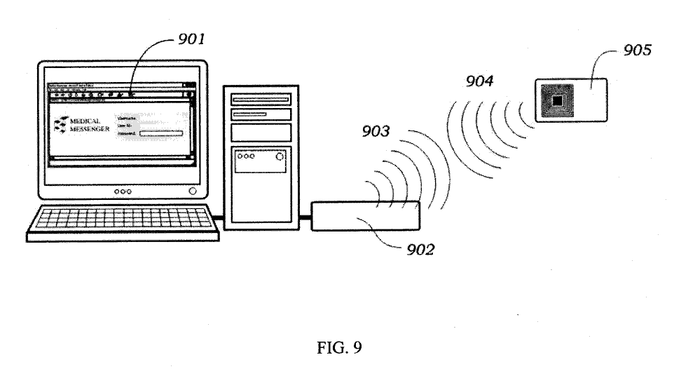

Using the same process as in the local network, the central database 103 correlates patient information with product data and assembles them for transmission back to the client computer 114. However, because the global Internet 104 offers far less security than the physically protected local network 108-113, an additional validation process using an electronic access card may be provided. This is described in more detail in the embodiment illustrated in FIG. 9.

FIG. 2A shows the web portal for the manufacturer, producer or advertiser of a drug, a medical product or service. The advertiser logs in into a secure site via a registration page 200. This screen may require three pieces of information—the advertiser's user name 201, identification number 202 and password 203. Once these data are logged and verified the advertiser is granted assess to an advertisement edit web page 220, shown in FIG. 2B.

FIG. 2B shows the advertisement edit web page 220 which allows the advertiser to enter a list of keywords 204. These keywords may include a list of conditions, medications, procedures, locations or any other specific patient information. Since the advertiser has no access to patient information, these terms represent only possible matches to actual patient records. Beyond keywords, this field may also include more complex queries, filters, macros or algorithms. For example, a possible entry could be “cough AND temp >100.0 F.” This allows advertisers more control over the triggering of promotional information.

In the current embodiment, the actually advertisement is quite simple. It consists of a title 205, link 206 and text 207. Obviously, other embodiments within the scope of this invention may include more complex text, hypertext, imagery or media. These are well describe in many world wide web (W3C) standards, such as the hypertext markup language (HTML), cascading style sheets (CSS), extensible markup language (XML), JavaScript, and others.

These advertisement data are stored in a central data base 105 and disseminated periodically from the central server 103 to local servers 108. In all cases, the advertisers are unaware of which patients, patient populations or clinics view or access the promotional information.

FIG. 3A shows the login page and FIG. 3B shows the main screen for access to patient information. The login screen 300, FIG. 3A, provides corporate identification information 301, access and legal data 302. User input includes the user name 303, user identification number 304 and user password 305. These three pieces of information are logged and verified before access is granted to the user. Other entrance schemes may include biometrics or user identification devices, such as a credit card, bar code or radio frequency identification (RFID) “smart” card, as described in more detail in FIG. 9.

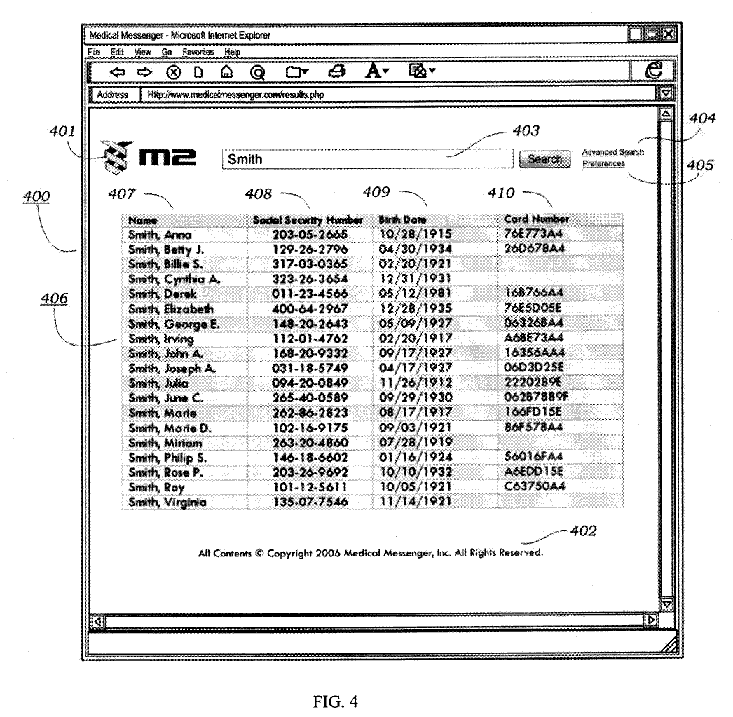

The main interface to the patient record is a simple, yet powerful search screen 330, FIG. 3B. In addition to corporate and legal information 301 and 302, the main web page includes a search term text box 306 and button 307. Terms entered in the search field 306 are matched to any key word or field in the patient record. These terms may include a patient's name, primary care physician, medical condition, pharmaceutical, medical term, dates, addresses, phone numbers, etc. In short, any element of the patient record may be search on to quickly find the information. The current embodiment also embodies “wildcards” to aid search. For example, “sm*” returns all entries containing keywords that begin with the letters “s” and “m.” These records are then sorted and displayed in the results screen, described more fully in FIG. 4. In addition an “Advanced Search” link 308 may be selected to perform a more narrow search. There is also a “Preferences” link 309 to further define the search.

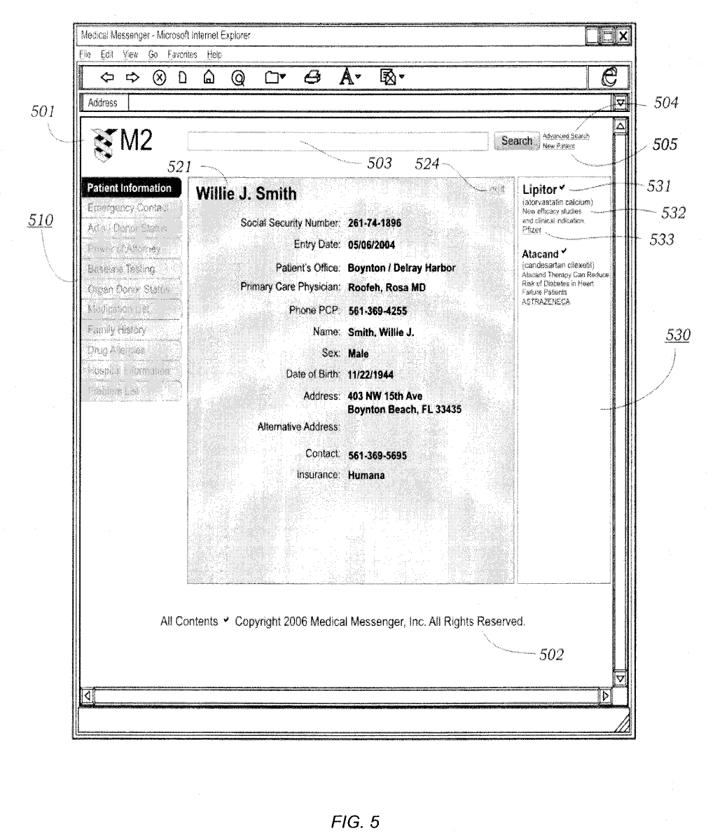

FIG. 4 shows the search results page. This interface includes corporate identification and legal information 401 and 402, as well as a replication of the main search interface components search field 403, Advanced Search 404 and Preferences 405. In the preferred embodiment, the results are shown in a table 406 and include the patient's name column 407, their social security number column 408, their birth date column 409, and a patient identification number column 410. This patient identification number in the preferred embodiment may also correspond to a patient card number. The selection of a patient on the results page immediately links the user to the patient record page 500, described more fully in FIG. 5.

FIG. 5 shows the patient record page. This page consist of search and information elements of the main page 501-505, as well as three panels: the navigation panel 510, information panel 521, and advertisement panel 530. The navigation panel 510, in the preferred embodiment, includes links to eleven sub-pages. These include general patient information, emergency contact information, AD's/donor status, power of attorney, baseline testing, organ donor status, medication list, family history, drug allergies, hospital information and problem list. Each of these links to a specific sub-page with information format similar to that presented in 521. The information panel includes the patient name and a set of key value pairs, where the keys 522 are right justified against the matching values 523. Finally, the product promotional panel 530 displays the list of manufacturer advertisement based on the specific patient information triggered using the information provided by the advertiser. This panel 530 includes a set of advertisements which comprise a title 531, text description 532 and link 533. This current embodiment uses only simple text-based advertisement, which other implementations are possible, including hypertext, images, media, or Macromedia Flash™ animations. The preferred embodiment is simple text promotions in panel 530, as media rich displays are distracting to the user. Finally, an edit key 524 enables patient record editing for those with edit privileges. In fact, in the current embodiment the edit key is visible only to those with such privileges.

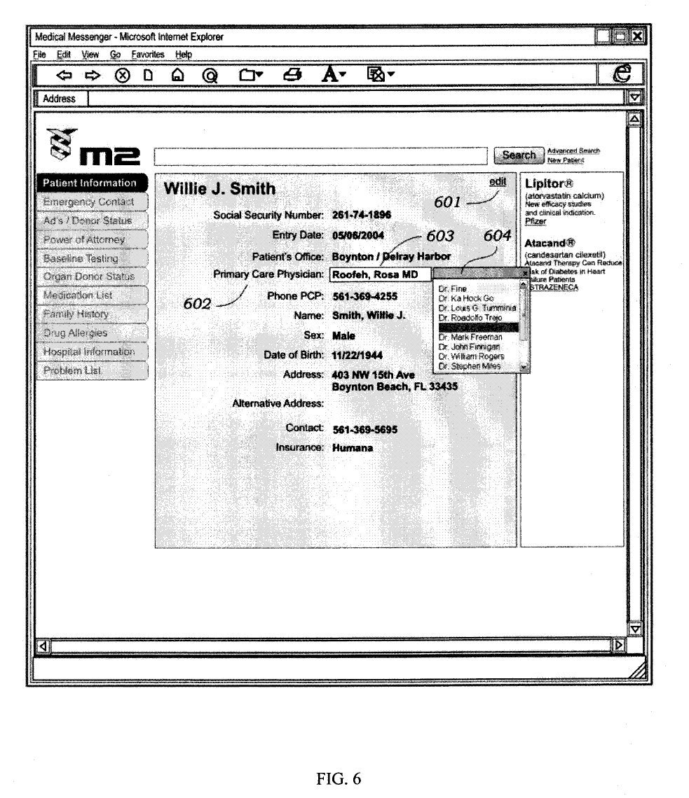

FIG. 6 shows the patient record editing capability. With editing enabled, as indicated with the highlighted label 601, any patient record can be modified. In the current embodiment a value of any key 602 may be selected. Once selected, an edit box 603 and an edit “widget” 604 are presented. The edit box 603 allows direct user input, while the edit “widget” 604 aides the user in the selection of appropriate values. This “widget” varies depending on the nature of the field. For example, selecting a date field will present a calendar “widget.”

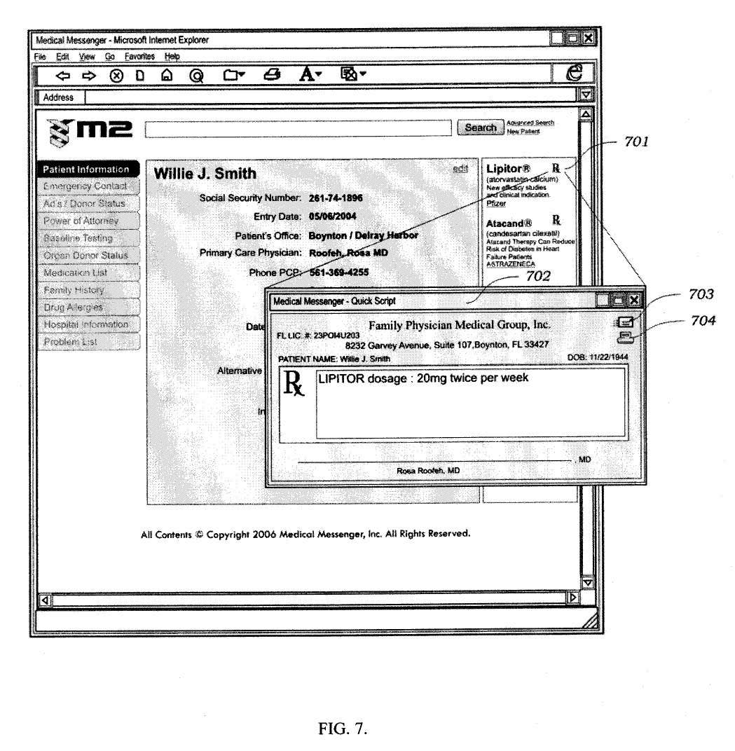

FIG. 7 illustrates an enhancement to the preferred embodiment. In this enhancement a link 701 is added to the promotional information on the advertisement panel 530. This link 701, represented as a small Rx icon, when selected will launch a prescription interface 702. The prescription interface 702 fills out the order template with as much information as can be deduced from the patient record, physician and selection. All the information, of course, may be view, changed and approved by the physician. The template facilitates an order process and minimizes errors.

The prescription interface 702 may also include an electronic mail button 703 and/or a print button 704. The electronic mail button 703 immediately sends and then archives an electronic message to a particular pharmacy. The print button 704 prints a hard copy of the prescription for physician signature.

The appearance and order of the advertisements may be based on bidding or competitive auction among the advertisers. The presentation of a particular advertisement may be purchased based on time and duration or on particular keywords or sets of keywords. In this way advertisement presentation precedence and frequency can be more closely correlated to advertisement fees.

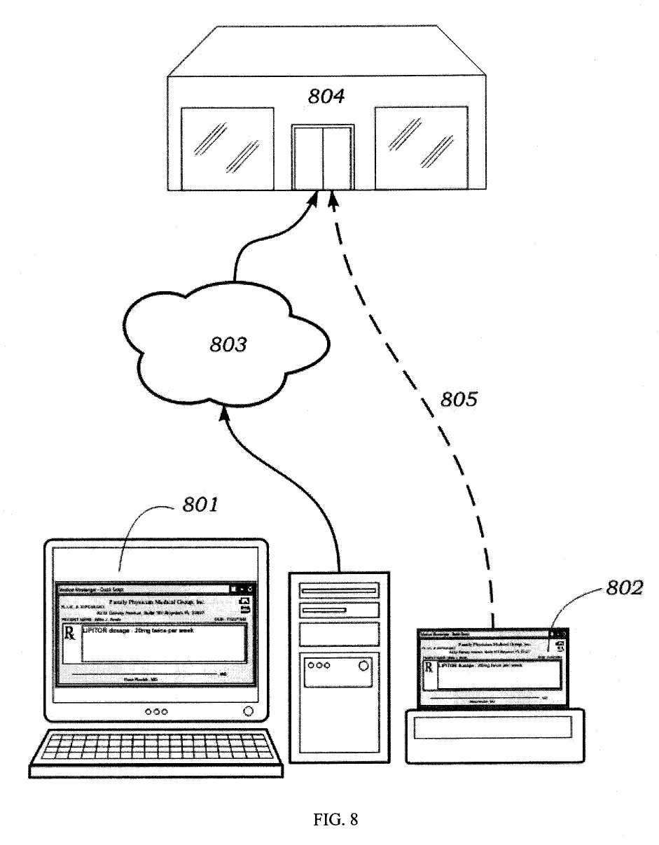

FIG. 8 shows schematically the advantage of using both electronic and print copies of the prescription. By correlating the print copy 802 that is given to the patient and received by the pharmacy 804 with an electronic copy 801 sent directly to the pharmacy, via the Internet 803, may help reduce medical error and prescription fraud.

FIG. 9 shows a second embodiment. A radio frequency identification (RFID) card 905 is used to gain access to the healthcare information system. A signal 903 from the RFID reader 902 interrogates the RFID card 905 which responses via a reflect signal 904 back to the reader 902. The RFID card 905 reflects back to the reader user identification information 901 which is used by itself or in conjunction with user supplied information, such as user name, user identification number and password to access to the patient records. The advantage to this embodiment is the greater security through an additional validation mechanism, as well as the ease of use through automatic card access.

Additional access mechanisms within the scope of this invention include magnetic strip access cards, bar code tags, smart cards, and biometric authentication including fingerprint, iris, facial contour, and voice print.

Any of the various features of the invention disclosed herein may be employed in a wider variety of systems. The invention disclosed herein also includes the method of operating the system. The invention further includes any means for storing or disseminating a digitally encoded set of instructions to operate the system. The instructions may be accessed by or disseminated to a processor. Those skilled in the art will appreciate that modifications and variations may be made to the above disclosed embodiments without departing from the spirit and scope of the invention.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly of after either or both of the following: a) conversion to another language, code or notation; b) reproduction in a different material form.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A computer implemented medical record database management system comprising:
patient identifying information for one of a plurality of patients;
said patient identifying information associated with a corresponding medical data record of said patient;
means for permitting a healthcare product or service supplier to enter an advertisement for a healthcare product or service on said medical record database management system without knowledge of specific patients' information;
means associating said advertisement for a healthcare product or service with a relevant medical condition of one or more of said patients and means to enable said one or more patients to access said advertisement for a healthcare product associated with said patient's relevant medical condition.

2. The medical record database management system of claim 1, wherein said advertisement for a healthcare product or service is a prescription for a pharmaceutical product and means enabling said patient to select said prescription and means for enabling said patient's physician to write said prescription for said pharmaceutical product.

3. The medical record database management system of claim 2 further including means to electronically send said prescription to a pharmacy after approval by said physician.

4. The medical record database management system of claim 2 further including means to print out a hard copy of said prescription for said physician's approval.

5. The medical record database management system of claim 1 further including a patient information display; said display including means to modify said patient information by authorized individuals.

6. The medical record database management system of claim 1 further including means to enable wireless devices to communicate with said medical record database management system.

7. The medical record database management system of claim 1 wherein said means associating said advertisement for a healthcare product or service with a relevant medical condition of one or more of said patients includes key words identifying said relevant medical condition.

8. The medical record database management system of claim 1 further including means to provide authorized individuals access to said medical record database management system, wherein said means to provide authorized individuals access are selected from the group consisting of login identifications, magnetic strip access cards, bar code tags, smart cards and biometric authentication.

9. A method of managing a medical record database management system comprising:
inputting patient identifying information for one of a plurality of patients;
associating said patient identifying information with a corresponding medical data record of said patient;
permitting a healthcare product or service supplier to enter an advertisement for a healthcare product or service on said medical record database management system without knowledge of specific patients' information;
associating said advertisement for a healthcare product or service with a relevant medical condition of one or more of said patients and enabling said one or more patients to access said advertisement for a healthcare product or service associated with said patient's relevant medical condition.

10. The method of managing a medical record database management system of claim 9, wherein said advertisement for a healthcare product or service is a prescription for a pharmaceutical product and enabling said patient to select said prescription and enabling said patient's physician to write a prescription for said pharmaceutical product.

11. The method of managing a medical record database management system of claim 10 further including electronically sending said prescription to a pharmacy after approval by said physician.

12. The method of managing a medical record database management system of claim 10 further including printing out a hard copy of said prescription for said physician's approval.

13. The method of managing a medical record database management system of claim 9 further including displaying said patient information and modifying said patient information by authorized individuals on said display.

14. The method of managing a medical record database management system of claim 9 further including enabling wireless devices to communicate with said database management system.

15. The method of managing a medical record database management system of claim 9 wherein associating said advertisement for a healthcare product or service with a relevant medical condition of one or more of said patients includes the use of key words identifying said relevant medical condition.

16. The method of managing a medical record database management system of claim 9 further including providing authorized individuals access to said medical record database management system; wherein said access is controlled by means selected from the group consisting of login identifications, magnetic strip access cards, bar code tags, smart cards, and biometric authentication.

17. A computer-readable medium storing computer executable process steps to manage a medical record database management system, the process steps comprising:
inputting patient identifying information for one of a plurality of patients;
associating said patient identifying information with a corresponding medical data record of said patient;
permitting a healthcare product or service supplier to enter an advertisement for a healthcare product or service on said medical record database management system without knowledge of specific patients' information;
associating said advertisement for a healthcare product or service with a relevant medical condition of one or more of said patients and enabling said one or more patients to access said advertisement for a healthcare product or service associated with said patient's relevant medical condition.

18. A computer readable medium according to claim 17, wherein said advertisement for a healthcare product or service is a prescription for a pharmaceutical product and enabling said patient to select said prescription and enabling said patient's physician to write a prescription for said pharmaceutical product.

19. A computer readable medium according to claim 18 further including electronically sending said prescription to a pharmacy after approval by said physician.

20. A computer readable medium according to claim 18 further including printing out a hard copy of said prescription for said physician's approval.

21. A computer readable medium according to claim 17 further including displaying said patient information and modifying said patient information by authorized individuals on said display.

22. A computer readable medium according to claim 17 further including enabling wireless devices to communicate with said database management system.

23. A computer readable medium according to claim 17 wherein associating said advertisement for a healthcare product or service with a relevant medical condition of one or more of said patients includes the use of key words identifying said relevant medical condition.
